(19) United States
(12) Patent Application Publication
(10) Pub. No.: US 2007/0102125 A1
(43) Pub. Date: May 10, 2007

(54) Sliding wheel unit for a blind

(75) Inventors: Ming Nien, Taichung (TW); Dejun Zhang, Chang pin Chen (CN)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/269,728

(22) Filed: Nov. 9, 2005

(51) Int. Cl. E06B 9/324

(52) U.S. Cl. 160/178.2

(57) ABSTRACT

A sliding wheel unit for a blind includes a base member and a friction member. The base member is provided with an exit hole in a rear wall, and the friction member is provided with a circumferential wall defining a center hole for a pull rope to extend out, a position edge formed at one side and a bottom wall at the other side. So after the friction member is inserted in the exit hole of the base member, the position edge and the bottom wall of the friction member contacts respectively the outer side and the inner side of the wall of the center hole of the base member to keep the friction member stable in place. Then the friction member can have a long service life, lessened in friction with the pull rope.

### BACKGROUND OF THE INVENTION

1. Field of the Invention

This invention relates to a sliding wheel unit for a blind, particularly to one having a friction member improved better than a conventional one.

2. Description of the Prior Art

A conventional sliding wheel unit for a blind shown in FIGS. 1 and 2 is installed on an upper rod of a blind at a proper location, including a base member 11 flexibly fitting firmly in the upper rod. The base member is provided with a hollow space 111 and a rack 112, an entrance hole 113 and an exit hole 114 respectively formed in a front wall and a rear wall for a pull rope to extend in and out. Further, a stationary wheel 12 is fixed upright in the hollow space 111, and a movable gear 13 is positioned beside the stationary wheel 12 to engage with the rack 112 in the hollow space 11. Then the pull rope extending in the base member 11 is sandwiched between the stationary wheel 12 and the rotatable gear 13 for fixing a blind body. Further, a U-shaped engage ring 14 is fitted in the exit hole 114 for the pull rope to be moved frictionally so that the pull rope may be prevented from snapping or worn down due to friction between the pull rope and the engage ring 14.

However, the U-shaped engage ring 14 may be liable to disfigure and fall off in case the U-shaped engage ring 14 receives sliding force of the pull rope when pulled, Moreover, the U-shaped engage ring 14 is not in good in its appearance, or not easy to control in its bending precision to result in low percentage of quality test and high cost.

### SUMMARY OF THE INVENTION

The feature of the sliding wheel unit for a blind in the invention is a friction member to fit in an exit hole of a base member. The friction member is provided with a circumferential wall defining a center hole for a pull rope of a blind to extend out. The circumferential wall of the friction member is provided with a position edge at an outer side and a bottom wall at the inner side, and the position edge contacts the outer side of the wall of the center hole of the base member and the bottom wall contacts the inner side of the wall of the center hole after the friction member is fitted in the exit hole of the base member, keeping it secured without falling off the center hole.

### BRIEF DESCRIPTION OF DRAWINGS

This invention will be better understood by referring to the accompanying drawings, wherein:

FIG. 1 is a perspective view of a conventional sliding wheel unit for a blind;

FIG. 2 is an exploded perspective view of the conventional sliding wheel unit for a blind;

FIG. 3 is a perspective view of a sliding wheel unit for a blind in the present invention;

FIG. 4 is an exploded perspective view of the sliding wheel for a blind in the present invention;

FIG. 5 is an upper cross-sectional view of a friction member fitted in place in the present invention; and, FIG. 6 is a perspective view of the sliding wheel unit installed on a blind in the present invention.

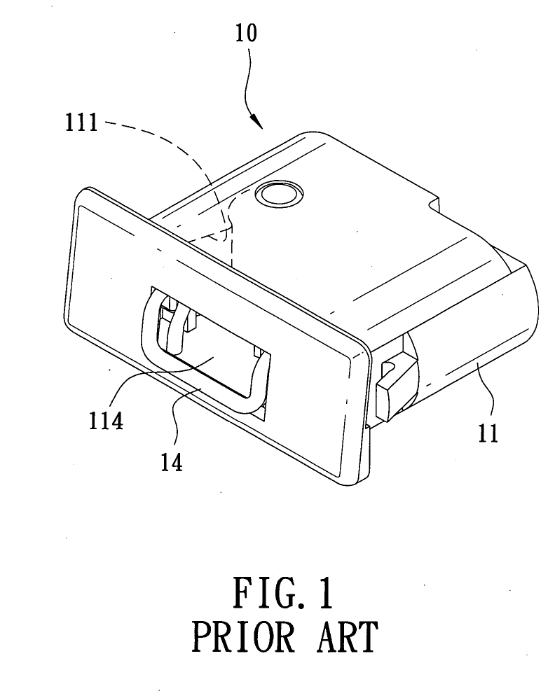

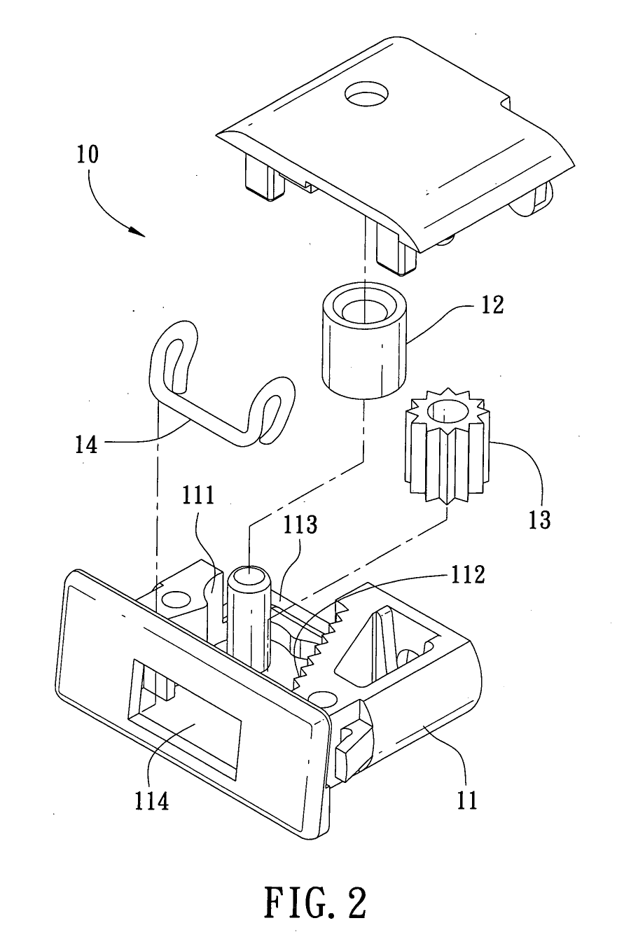

### DETAILED DESCRIPTION OF THE PREFERRED EMBODIMENT

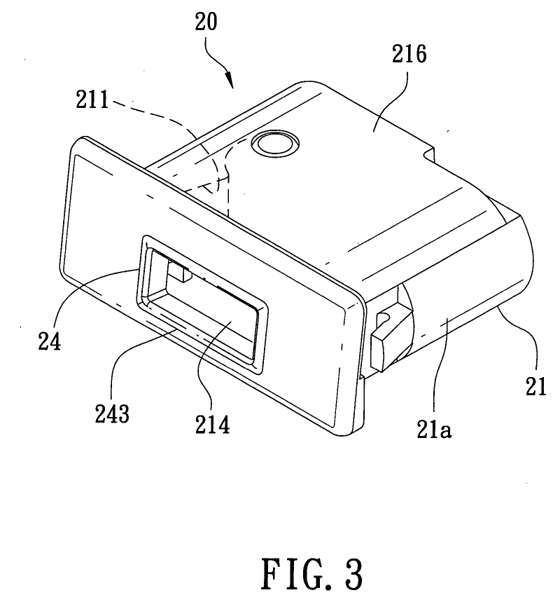

A preferred embodiment of a sliding wheel unit for a blind in the present invention, as shown in FIGS. 3, 4 and 5, has almost the same structure of the conventional sliding wheel unit for a blind, fitted flexibly in an upper rod of a blind at a proper location, including a base member 21 and a friction member 24.

The base member 21 consists of a bottom base 21 a and a cover 21b covered on the bottom base 21a, with a hollow space 211 defined by the bottom base 21a and the cover 21b. Further, a rack 212 is provided on the bottom base 21a, and an entrance hole 213 is formed in the front wall of the bottom base 21 a and an exit hole 214 is formed in the rear wall of the bottom base 21a, so a pull rope 40 may extend in through the entrance hole 211 and out of the exit hole 214. Further, a stationary wheel 22 is installed upright in the hollow space 211, and a rotatable gear 23 is also installed therein, engaging with the rack 22, so the pull rope 40 may be sandwiched properly between the stationary wheel 22 and the rotatable gear 23 for connecting firmly with a blind body 50 of the blind.

The stationary wheel 22 has teeth around its outer surface so that the pull rope 40 may be tightly pressed by the teeth of the stationary wheel 22 and the rotatable gear 23 after extending in and out of the base member 21 and between the both 22 and 23, but the stationary wheel 22 can also be a round column without teeth.

Next, the friction member 24 made integral of a metal or plastic is inserted in the exit hole 214 of the base member 21, consisting of a circumferential wall 241 defining a center hole 242, a position edge 243 formed projecting outward from the circumferential wall 241 and having a size a little larger than that of the exit hole 214 of the base member 21. Further, a bottom wall 244 is formed to extend vertically outward from the inner side of the circumferential wall 241 and sized larger than that of the exit hole 214. Then the position edge 243 extends just out of the exit hole 214 and contacts the outer side of the wall of the exit hole 214, and the bottom wall 244 contacts the inner side of the wall of the exit hole 214, keeping the friction member 24 in place securely.

The center hole 242 of the friction member 24 has an profile similar to that of the exit hole 214 of the base member 21 , almost shaped nearly rectangular with four corners curved to enable the pull rope 40 slide in and out smoothly and at the same time the frictional resistance of the wall of the center hole 242 can be low against the pull rope 40. Further, the bottom wall 244 of the friction member 24 is also shaped rectangular.

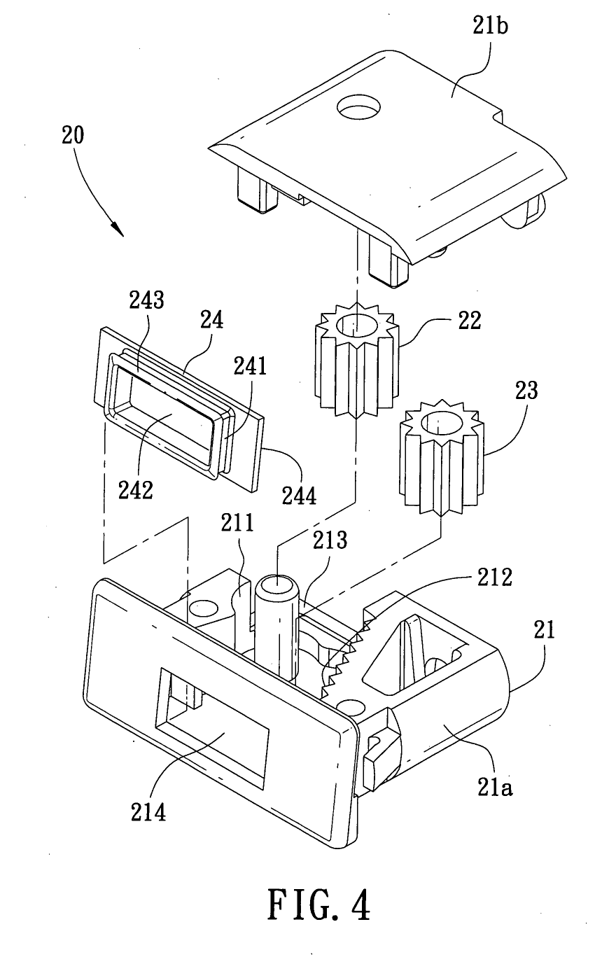

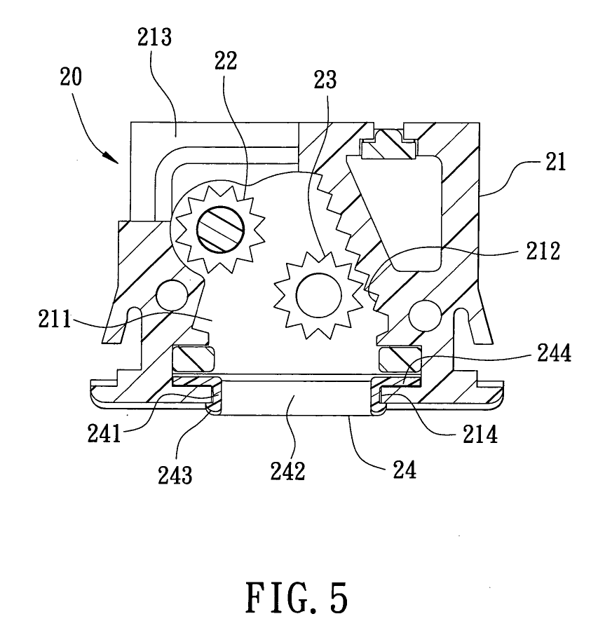

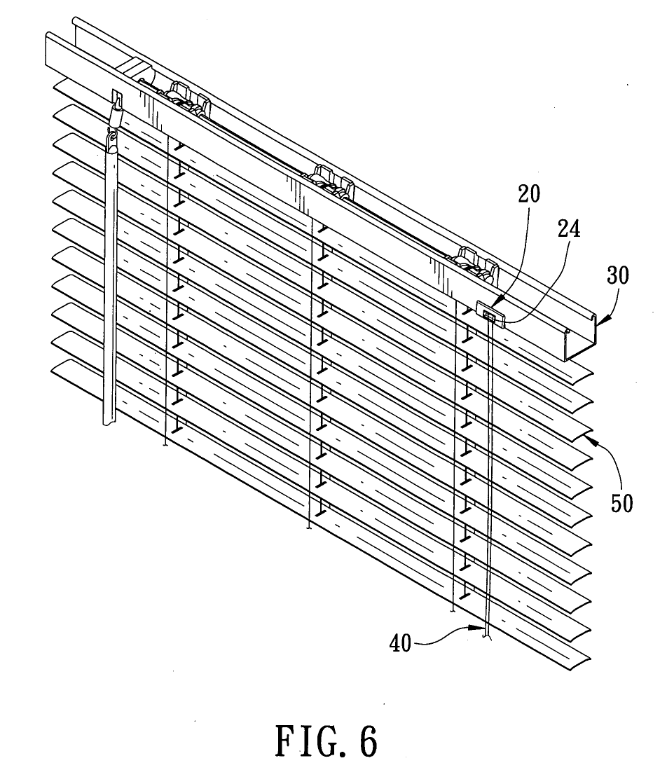

In addition, as shown in FIGS. 4 and 5, the friction member 24 of the slide wheel unit 20 can be inserted in the exit hole 214 of the base member 21, letting the position edge 243 of the circumferential wall 21 expose out of the exit hole 214 of the base member 21 before the cover 21b is covered on the bottom base 21a. Then the position edge 243 contacts the outer side of the wall of the exit hole 214 and the bottom wall 244 contacts the inner side of the wall of the exit hole 214, keeping the friction member 24 tightly secured in the exit hole 214.

In addition, after the slide wheel unit 20 is installed in the upper rod 30 of the blind, with the pull rope 40 is properly extended in the slide wheel unit 20, the friction member 24 may not become loose, or fall off, kept securely with the base member 21

Further, the frictional resistance of the pull rope 40 against the center hole 242 of the friction member 24 is substantially low, and at the same time, the friction member 24 is made of a material highly resistant against wear and tear, enabling the friction member 24 have a long service life.

Moreover, the friction member 24 has only a small portion of the circumferential wall 241 and the position edge 243 exposed out of the exit hole 214, with its profile coordinating with that of the exit hole 214, presenting comparatively beautiful appearance. Besides, the friction member 24 can be produced swiftly with high effectiveness because of pressing process with metal or plastic as its material.

While the preferred embodiment of the invention has been described above, it will be recognized and understood that various modifications may be made therein and the appended claims are intended to cover all such modifications that may fall within the spirit and scope of the invention.

What is claimed is:

1. A sliding wheel unit for a blind, said slide wheel unit installed on an upper rod of a blind, said slide wheel unit comprising:
a base member having an entrance hole and an exit hole for an pull rope to extend in and out;
a stationary wheel and a rotatable gear pivotally provided in said base member and engaging with a rack provided therein, said pull rope properly sandwiched between said stationary wheel and said rotatable gear; and,
a friction member made of a proper material and inserted secured in said exit hole of said base member, said friction member having a circumferential wall defining a center hole for said pull rope to move slidingly in and out.

2. The sliding wheel unit for a blind as claimed in claim 1, wherein said circumferential wall of said friction member has a bottom wall extending outward vertically from said circumferential wall and contacting an inner side of the wall of said exit hole, and a position edge extending outward from the outer side of said circumferential wall and exposing out of said exit to contact an outer side of the wall of said exit hole.

3. The sliding wheel unit for a blind as claimed in claim 1, wherein said friction member is made integral of metal by pressing process.

4. The sliding wheel unit for a blind as claimed in claim 1, wherein said friction member is made integral of plastic

5. The sliding wheel unit for a blind as claimed in claim 1, wherein said center hole of said friction member is shaped rectangular with four corners curved.

6. The sliding wheel unit for a blind as claimed in claim 1, wherein said position edge of said friction member has its outer side curved.

7. The sliding wheel unit for a blind as claimed in claim 2, wherein said bottom wall of said friction member is shaped rectangular.

8. The sliding wheel unit for a blind as claimed in claim 1, wherein said stationary wheel has its outer surface formed with plural teeth.
